(19) United States
(12) Patent Application Publication
(10) Pub. No.: US 2007/0045551 A1
(43) Pub. Date: Mar. 1, 2007

(54) Camera module apparatus with IR-cut-coated window glass

(75) Inventor: Min Chul Go, Suwon-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon-si (KR)

(21) Appl. No.: 11/508,914

(22) Filed: Aug. 24, 2006

(30) Foreign Application Priority Data
Aug. 30, 2005 (KR) 10-2005-0080143

(51) Int. Cl. G01T 1/24

(52) U.S. Cl. 250/370.08

(57) ABSTRACT

The present invention relates to a camera module apparatus with an IR-cut-coated window glass including a lower housing; a printed circuit board that is installed on the lower housing and is provided with an image sensor; a lens holder that is installed on the printed circuit board and is provided with a lens above the image sensor; a window glass that is installed above the lens and is IR-cut-coated; and an upper housing that has an opening formed above the window glass and is coupled to the lower housing.

### CROSS-REFERENCE TO RELATED APPLICATIONS

The application claims the benefit of Korea Patent Application No. 2005-0080143 filed with the Korea Intellectual Property Office on Aug. 30, 2005, the disclosure of which is incorporated herein by reference.

### BACKGROUND OF THE INVENTION

1. Field of the Invention

The present invention relates to a camera module apparatus, and more specifically, to a camera module apparatus with an IR-cut-coated window glass in which an IR filter and a window are integrated so as to reduce a cost in a camera module, to improve optical characteristics, and to reduce a time for design and manufacturing.

2. Description of the Related Art

Recently, more and more mobile phones are adopting a camera module. Specially, more than 50% of mobile phones delivered in the market in 2005 have adopted a camera module.

Meanwhile, as a method of packaging a camera module for mobile phone, there are provided a flip chip chip-on-film (COF) method, a wire bonding chip-on-board (COB) method, a chip scale package (CSP) an the like.

The COB method is a similar process to that of an existing semiconductor production line and has higher productivity than other packaging methods. However, since wire should be used for the connection with a PCB, the size of a module increases and an additional process is needed. Therefore, a new packaging technique is required to reduce the size of chip, to enhance heat emission and electrical performance, and to improve reliability. Accordingly, a COF method has emerged, based on bumps having an external bonding projection.

In the COF method, a space for attaching wire is not needed. Therefore, the area of a package and the height of a lens barrel can be reduced. Further, since a thin film or flexible printed circuit board (FPCB) is used, a reliable package which endures an external impact can be manufactured and the process thereof is relatively simplified. Moreover, the COF method satisfies such a tendency that signals are processed at high speed, high density is required, and multiple pins are needed.

The COF method is implemented as chip size wafer-scale packaging. However, a process cost of the method is expensive, and the correspondence to the due date is unstable. Therefore, the method has a limit as a method for image sensor.

Further, as a mobile phone maker demands the miniaturization of camera phone and the reduction in cost, a countermeasure against the demand is urgently required.

Then, the structure of a conventional camera module and the problems thereof will be described with reference to accompanying drawings.

FIG. 1 is an exploded perspective view illustrating a camera module apparatus according to the related art.

As shown in FIG. 1, the conventional camera module 10 includes an upper housing 1 provided with an opening 1a, a window glass 2 which is installed below the opening 1a, a lens 3 which is installed below the window glass 2, a lens holder 4 which fixes the lens 3, an IR cut filter 5 which is installed below the lens holder 4 having the lens 3 fixed thereto, an image sensor 8 which is installed below the IR cut filter 5, a printed circuit board (PCB) 6 which fixes the image sensor 8, and a lower housing 7 which is installed below the printed circuit board 6 and is coupled to the upper housing 10.

The printed circuit board 6 has an opening (not shown) formed below the IR cut filter 5, and the image sensor 8 is installed in one side of the opening. The image sensor 8 serves to process received image signals, and the IR cut filer 5 serves to cut infrared rays incident from the outside.

In the conventional camera module 10 having the above-described construction, a position where the IR cut filter 5 is attached differs depending on the COF and COB methods.

In the COF method, the image sensor 8 is attached on the printed circuit board (PCB) 6, and the IR cut filter 5 is then attached on the image sensor 8. In the COB method, the image sensor 8 is connected to the printed circuit board 6 by using a wire bonding method, and the IR cut filter 5 is then attached on the inside of the upper housing 5 by using an adhesive.

The camera module using the COF or COB method uses the window glass 2.

In the conventional camera module 10, however, the IR cut filter 5 and the window glass 2 are used separately, thereby increasing a manufacturing cost.

Further, when light is transmitted to the image sensor 8, the light should pass through the window glass 2 and the IR cut filter 5. Therefore, the transmittance thereof decreases, so that the amount of light becomes insufficient.

In the COB method, as the IR cut filter 5 is assembled into the housing, an assembling cost is additionally required, thereby increasing a manufacturing cost.

Further, in the COB method, a module quality can be deteriorated by the contact with wire, which occurs because of a short distance between the image sensor 8 and the IR cut filter 5 when the IR cut filter 5 is assembled into the housing.

In the COF method, productivity decreases due to an attaching process in which the IR cut filer 5 is attached on the image sensor 8.

### SUMMARY OF THE INVENTION

An advantage of the present invention is that it provides a camera module apparatus with an IR-cut-coated window glass, in which IR cut coating is performed on a window glass of the camera module in order to remove an existing IR-cut filter, thereby reducing a cost, improving optical characteristics, and reducing a time for design and manufacturing.

Additional aspects and advantages of the present general inventive concept will be set forth in part in the description which follows and, in part, will be obvious from the description, or may be learned by practice of the general inventive concept.

According to an aspect of the invention, a camera module apparatus with an IR-cut-coated window glass includes a lower housing; a printed circuit board that is installed on the lower housing and is provided with an image sensor; a lens holder that is installed on the printed circuit board and is provided with a lens above the image sensor; a window glass that is installed above the lens and on which IR cut coating is performed; and an upper housing that has an opening formed above the window glass and is coupled to the lower housing.

According to another aspect of the invention, the IR cut coating is performed on one surface of the window glass.

According to a further aspect of the invention, the IR cut coating is performed on both surfaces of the window glass.

According to a still further aspect of the invention, the IR cut coating is performed on one surface of the window glass, and anti-reflection coating is performed on the other surface thereof.

According to a still further aspect of the invention, the IR cut coating is formed to have a thickness of 640 to 660 nm.

According to a still further aspect of the invention, the printed circuit board is a flexible printed circuit board (F-PCB).

According to a still further aspect of the invention, the printed circuit board is a rigid flexible printed circuit board (RF-PCB).

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is an exploded perspective view illustrating a camera module apparatus according to the related art; and

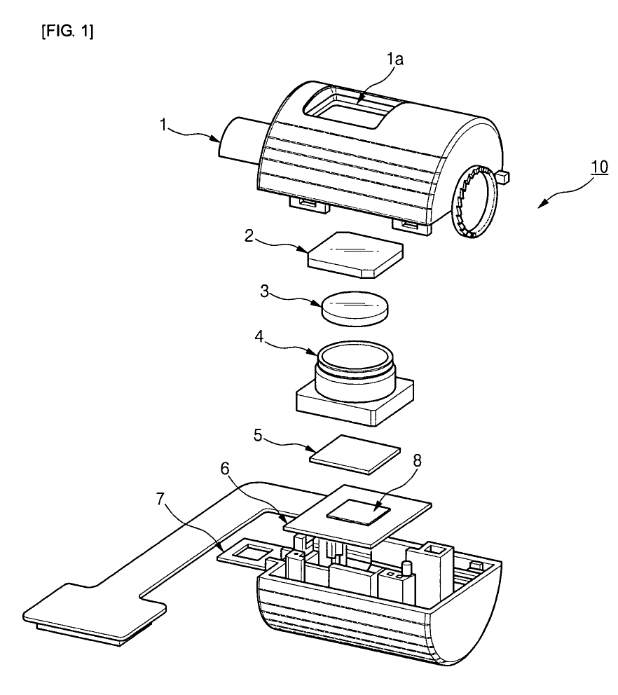

FIG. 2 is an exploded perspective view illustrating a camera module apparatus with an IR-cut-coated window glass according to the present invention.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

Hereinafter, a preferred embodiment of the present invention will be described in detail with reference to the accompanying drawings.

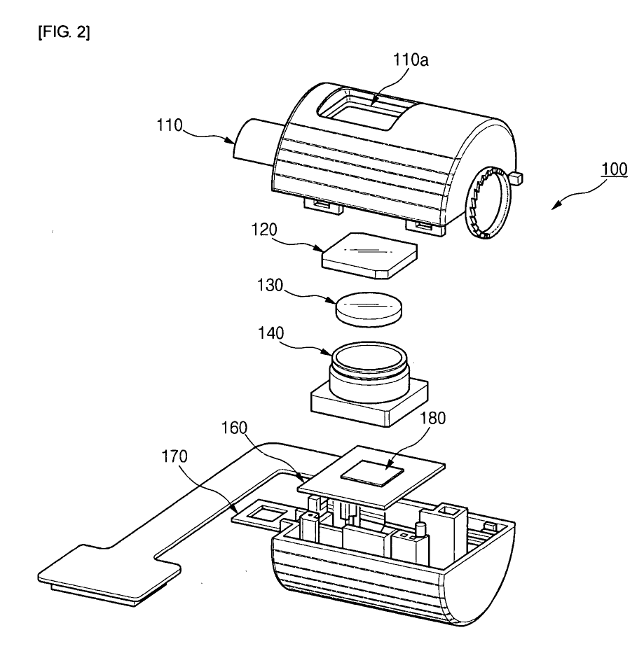

FIG. 2 is an exploded perspective view illustrating a camera module apparatus with an IR-cut-coated window glass according to the present invention.

As shown in FIG. 2, the camera module apparatus with an IR-cut-coated window glass according to the invention includes an upper housing 110 provided with an opening 110a, a lower housing 170 which is coupled to the upper housing 110, a printed circuit board (PCB) 160 which is provided with an IR-cut-coated window glass 120, a lens holder 140 having a lens 130, and an image sensor 180, which are sequentially installed between the upper and lower housings 110 and 170.

Below the opening 110a of the housing 110, the IR-cut-coated window glass 120 is installed inside the upper housing 110, as in the above-described construction.

The window glass 120 has IR cut coating of 640 to 660 nm formed on one surface or both surfaces thereof. If the IR cut coating has a thickness of less than 640 nm, it is impossible to expect an IR cutting effect. If the IR cut coating has a thickness of more than 660 nm, it is difficult to secure a sufficient amount of light which is to be transmitted to the image sensor.

When the IR cut coating is formed on both surfaces of the window glass 120, anti-reflection coating which has been performed on the window glass 120 does not need to performed.

Meanwhile, when the IR cut coating is formed on only one surface of the window glass 120, anti-reflection coating is preferably performed on the other surface in order to improve transmittance.

Since the IR-cut-coated window glass 120 according to the invention also plays a role of a conventional IR cut filter, the camera module apparatus does not need to include a separate IR cut filter.

Meanwhile, a flexible printed circuit board (F-PCB) or rigid flexible printed circuit board (RF-PCB) as the printed circuit board (PCB) 160 can be used to compose an image sensor module through a COF or COB packaging method.

In the COF packaging method, the printed circuit board 160 has such an opening that the light transmitted through the window glass 120 and the lens 130 is delivered to the image sensor 180. In the opening, the image sensor 180 is installed, which serves to process received image signals as in the related art.

That is, in the COF packaging method, the image sensor 180 is attached on the printed circuit board 160, and then the lens holder 140 provided with the lens 130 is immediately installed without an IR cut filter which has been installed on the image sensor 180.

Therefore, it is possible to omit a process in which the IR cut filter is attached on the image sensor.

In the COB packaging method, the image sensor 180 is connected to the printed circuit board 180 by using a wire bonding method. Then, the lens holder 140 provided with the lens 130 is immediately installed. In this case, a process in which an IR cut filter is attached inside the housing is omitted.

Therefore, it is possible to reduce a cost required when the IR cut filter is assembled into the housing. Further, it is possible to prevent quality deterioration caused by the contact with wire, which occurs because of a short distance between the image sensor and the IR cut filter when the IR cut filter is assembled into the housing.

According to the camera module apparatus with an IR-cut-coated window glass of the invention, the transmittance is enhanced by the integration of an IR filter and window, thereby improving optical performance. Further, it is possible to reduce a cost, because an existing IR cut filter does not need to be used.

Further, since an attaching process where an IR filter is attached on an image sensor does not need to be performed, it is possible to enhance productivity and to improve process fraction defective related to an IR filter.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A camera module apparatus with an IR-cut-coated window glass comprising:
a lower housing;
a printed circuit board that is installed on the lower housing and is provided with an image sensor;
a lens holder that is installed on the printed circuit board and is provided with a lens above the image sensor;
a window glass that is installed above the lens and on which IR cut coating is performed; and
an upper housing that has an opening formed above the window glass and is coupled to the lower housing.

2. The camera module apparatus according to claim 1,
wherein the IR cut coating is performed on one surface of the window glass.

3. The camera module apparatus according to claim 1,
wherein the IR cut coating is performed on both surfaces of the window glass.

4. The camera module apparatus according to claim 1,
wherein the IR cut coating is performed on one surface of the window glass, and anti-reflection coating is performed on the other surface thereof.

5. The camera module apparatus according to claim 1,
wherein the IR cut coating is formed to have a thickness of 640 to 660 nm.

6. The camera module apparatus according to claim 1,
wherein the printed circuit board is a flexible printed circuit board (F-PCB).

7. The camera module apparatus according to claim 1,
wherein the printed circuit board is a rigid flexible printed circuit board (RF-PCB).
